(19) United States
(12) Patent Application Publication
(10) Pub. No.: US 2014/0067624 A1
(43) Pub. Date: Mar. 6, 2014

(54) ACCESSING A SHOPPING SERVICE THROUGH A GAME CONSOLE

(71) Applicant: Doina Babu, Copenhagen (DK)

(72) Inventor: Doina Babu, Copenhagen (DK)

(73) Assignee: Microsoft Corporation, Redmond, WA (US)

(21) Appl. No.: 13/603,422

(22) Filed: Sep. 5, 2012

(51) Int. Cl. G06Q 30/00

(52) U.S. Cl. 705/27.2

(57) ABSTRACT

An input device to a game console allows a user to access a shopping service. A user interface display allows the user to browse and shop through a natural user interface on the input device.

### BACKGROUND

Shopping has become a common activity for many people. However, shopping can also be a time consuming and cumbersome process. Retail establishments are often very crowded, and miles away. In addition, though there are department stores and shopping malls, a shopper must often go to several different retail stores in order to accomplish a given shopping task. This normally involves driving (or taking some other type of transportation) to a retailer, sifting through products, waiting in line to try on apparel and check out, and then either going to another shopping facility or traveling back to one's home.

Shopping can be even more difficult when the shopper lives in a remote location, where retail establishments are not close by. In such a situation, the shopping tasks can be more time consuming and expensive, due to the high transportation costs.

There are currently a number of different on-line shopping mechanisms. That is, the shopper can go on-line and access retail or wholesale or other stores. The on-line shopping experience usually requires a user to navigate to the website for a specific store, look through the product offering of that store, and select a product, and then check out using some type of payment mechanism (such as credit card, etc.).

There are problems associated with this type of on-line shopping. One problem corresponds to the user interface and user experience for current on-line shopping. The user can not examine a desired product closely, but can only view perhaps a single image of the product. This problem becomes exacerbated when the article that is to be purchased is an article of clothing or other item that needs to be sized. The user cannot try on the item for proper sizing, nor can the user see what the item looks like when the user is wearing the item. It is currently believed that, due to these types of problems, fully one-third of all on-line clothing purchases are returned.

The discussion above is merely provided for general background information and is not intended to be used as an aid in determining the scope of the claimed subject matter.

### SUMMARY

An input device to a game console allows a user to access a shopping service. A user interface display allows the user to browse and shop through a natural user interface on the input device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIGS. 1 and 1A are block diagrams of one illustrative embodiment of a shopping system.

FIG. 1B shows one example of body part joints that can be identified.

FIGS. 2A and 2B show one embodiment of a flow diagram illustrating the operation of the system shown in FIG. 1

FIGS. 2C-2J are illustrative user interface displays.

FIGS. 3A and 3B show a flow diagram illustrating one embodiment of the operation of the system shown in FIG. 1 in taking a measurement of a body part.

FIG. 3C shows one embodiment of measurements that can be taken.

FIG. 4 is a block diagram showing various architectures.

FIGS. 5-9 show various embodiments of mobile devices.

FIG. 10 is a block diagram of one embodiment of a computing environment.

### DETAILED DESCRIPTION

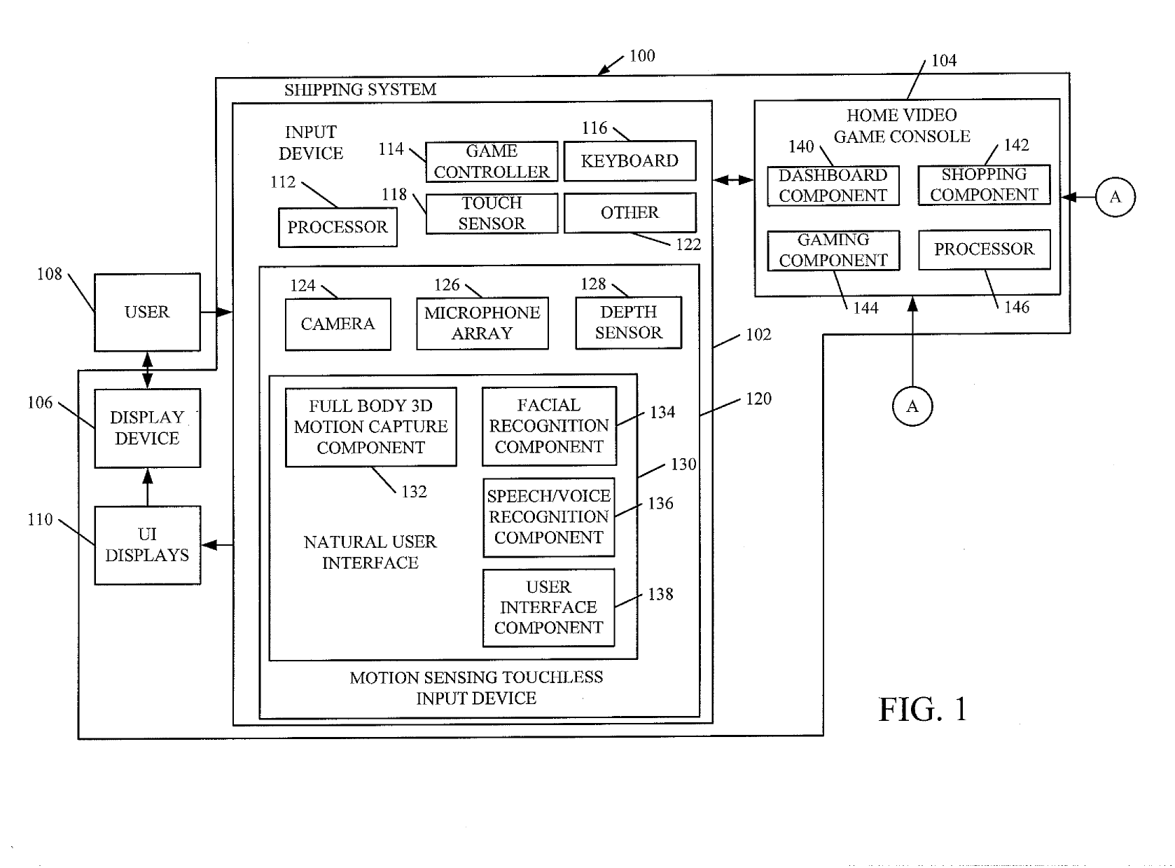

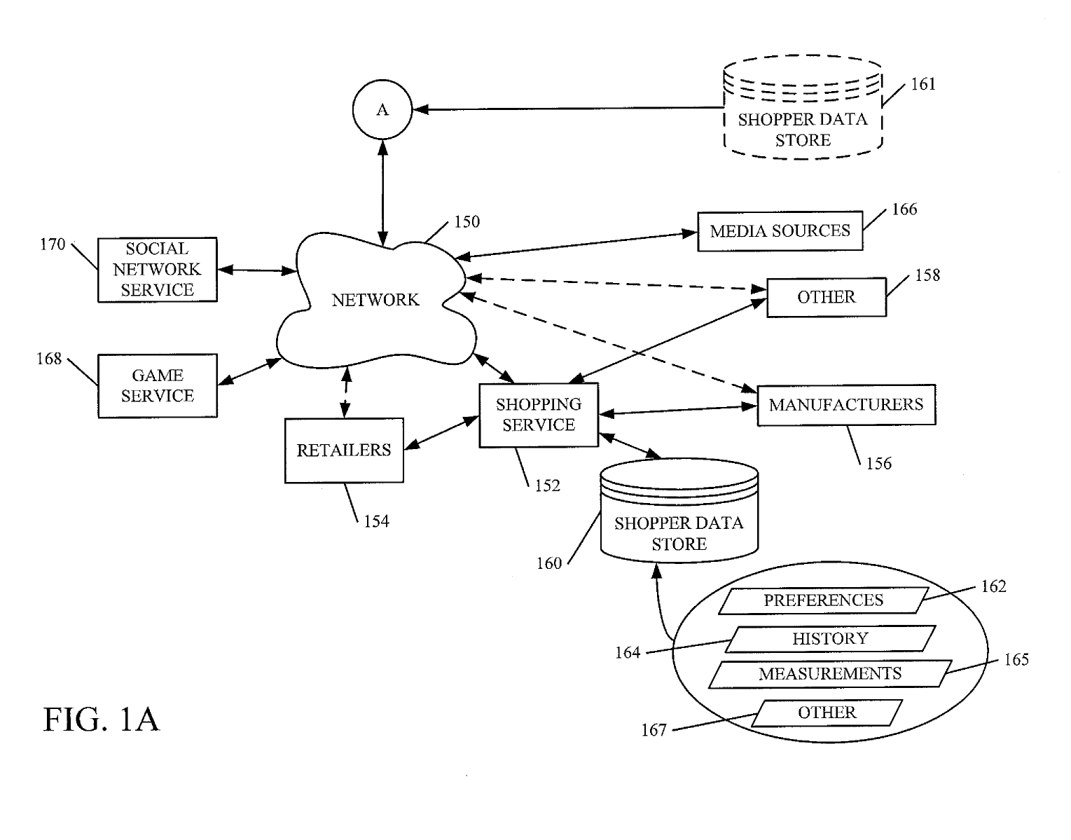

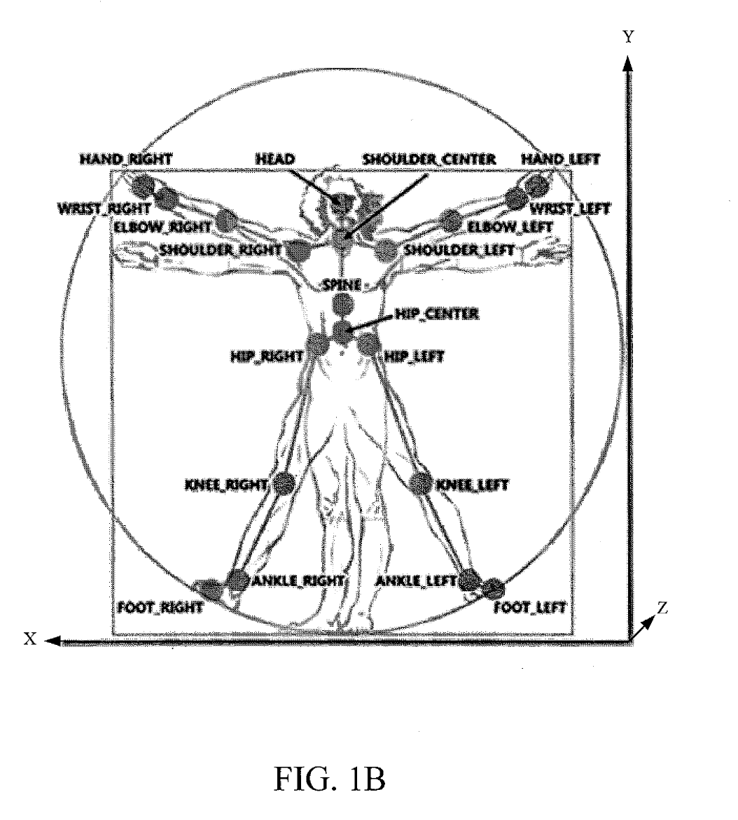

FIGS. 1 and 1A (collectively referred to as FIG. 1) show a block diagram of one illustrative shopping system 100. System 100 includes input device 102 and home video game console 104, along with display device 106. Input device 102 allows user 108 to provide inputs to, and interact with, video game console 104, and the items that are accessed by console 104. In doing so, input device 102 also illustratively provides user interface displays 110 that are displayed to user 108 using display device 106.

Input device 102 illustratively includes processor 112. Processor 112 is, by way of example, a computer processor with associated memory and timing circuitry (not shown). Processor 112 is illustratively a functional part of input device 102 and facilitates the functionality of the various components and other items in input device 102. Of course, the items of input device 102 can have their own processors, but only a single processor 112 is shown for input device 102, as one exemplary embodiment.

In the embodiment shown, input device 102 can include game controller 114, keyboard 116, touch sensors 118, motion sensing touchless input device 120, or other user input mechanisms 122. Also, in the embodiment illustrated, motion sensing touchless input device 120 includes camera 124, microphone array 126, depth sensor 128 and natural user interface 130. Natural user interface 130, itself, illustratively includes full body three-dimensional (3D) motion capture component 132, facial recognition component 134, speech/voice recognition component 136 and user interface component 138. User interface component 138 can use all of the items of input device 102 to generate user interface displays 110.

Display device 106 can be any device that displays user interface displays 110 to user 108. Display device 106 illustratively provides user interface displays 110 with user input mechanisms that allow the user to provide user inputs to the system. Display device 106 can be a display screen, a television screen, a touch sensitive display screen, a monitor, a phone display, a display on a tablet computer, or other type of display device. The user input mechanisms can illustratively receive user inputs through touch gestures, a keyboard (either a soft keyboard or a hardware keyboard), a point and click device (such as a mouse or track ball), voice inputs, touchless body gestures, etc.

In the embodiment shown in FIG. 1, video game console 104 illustratively includes dashboard component 140, shopping component 142, gaming component 144 and processor 146. Processor 146, like processor 112, is illustratively a computer processor with associated memory and timing circuitry (not shown). Of course, there can be more than one processor in video game console 104, but the single processor 146 is shown for the sake of example only.

Dashboard component 140 is controlled by shopping component 142 to illustratively generate a shopping dashboard that can be displayed as a user interface display 110 on display device 106, to user 108. Shopping component 142 illustratively provides shopping capabilities to user 108. The shopping capabilities are described in greater detail below and allow the user 108 to scroll through various products and offerings of various stores, to see sizing information and other information, and to buy products. Gaming component 144 illustratively runs games that can be played by user 108 and can perform other functions as well, such as play movies, or videos, etc.

FIG. 1 shows that shopping system 100 can be connected to network 150, which, itself, can be connected to shopping service 152. Shopping service 152 can be connected to retailers 154, manufacturers 156, or other sellers (even private persons) that wish to sell products as indicated by block 158. Similarly, retailers 154, manufacturers 156 and other sellers 158 can be connected directly to network 150 (as indicated by the dashed arrows), or to network 140 through shopping service 152, as well. Shopping service 152 also illustratively has access to shopper data in shopper data store 160. In one embodiment, the shopper data includes preferences and other settings 162 for individual shoppers and the shopping or browsing history 164 for the shoppers.

FIG. 1 also shows that shopping system 100 can be connected, through network 150, or otherwise, to other items such as media sources 166, game services 168 and social network services 170. Social network services 170, by way of example, can be any desired type of social networks which shopping system 100 provides access.

It can also be seen, that, in one embodiment, shopping services 152 can be implemented locally on console 104 using shopping component 142. In that case, video game console 104 can have access to shopper data in shopper data store 161, directly, and not through network 150. Both of these embodiments, and others, are contemplated. The present description proceeds, however, with respect to the embodiment in which shopping service 152 is accessed by shopping component 142 through network 150. This is exemplary only.

Before describing the operation of shopping system 100 in detail, the overall operation will be described briefly, for the sake of enhanced understanding. In one embodiment, input device 102 has natural language interface 130. Camera 124 can illustratively be a color VGA video camera that detects three color components (red, green and blue) to aid in facial recognition and other detection features. Depth sensor 128 illustratively includes an infrared projector that works with a monochrome sensor component 132 to capture three dimensional images, regardless of lighting conditions. Microphone array 126 can include, for instance, four microphones that can isolate voices of user 108 from other noise. Thus, component 136 can recognize and process voice controls from user 108.

In one embodiment, when user 108 first starts up system 100, device 102 reads the layout of the room and has user 108 make certain movements. Natural user interface 120 tracks, for example, forty-eight points on the body of user 108, mapping them to a digital reproduction of the body shape and skeletal structure (including joints and distances between joints) of user 108, including facial details. This is referred to as skeleton data for user 108. FIG. 1B shows some exemplary skeleton data that can be identified for user 108. Depth sensor 128 illustratively identifies a distance from the body of user 108 to each given pixel on sensor 128. Component 132 can perform full body three dimensional motion capture on the motions of the body of user 108 using this depth data. Therefore, user 108 can illustratively control the user interface items on user interface displays 110 by touchless user interaction (e.g., gestures identified by tracking the movements of user 108, or by the other means discussed above, such as touch gestures, voice, game controller 114, keyboard 116, etc.

User 108 can control game console 104 in this way to provide access to sources of media (such as videos, music, etc.) from media sources 166. User 108 can also use input device 102 to control video game console 104 to provide access to social networks or games through social network services 170 or game services 168, respectively. In addition, user 108 can control game console 104, using input device 102, to obtain access to shopping service 152 using shopping component 142. It is the shopping that is discussed in greater detail herein.

In order to shop using shopping service 152, dashboard component 140 of video game console 104 first illustratively displays a dashboard corresponding to the specific user 108 (or a more general dashboard). The dashboard allows user 108 to navigate through different items, and to drill down to specific products, and to perform other shopping operations. In allowing the user to do this, shopping component 142 accesses shopping service 152 to obtain data specific to shopper (or user) 108 from data store 160 but it also obtains information from retailers 154, manufacturers 156, or other sellers 158. When the user has eventually drilled down to a given product, the user can review the product, the size information for the product, various colors or other dimensions (such as style, configuration, etc.), whether the product is in stock and for which sellers, and the user can determine what types of sizes are in stock, and price information, and read reviews left by other users (with reviews by people in the user's social network highlighted, for example), among other things. In addition, shopping component 142 can include a measurement component that controls system 100 (and specifically device 102) the body of user 108 (such as to obtain the skeleton data) which can be stored in shopper data store 160. Therefore, shopping component 142 can identify whether the given product is available in the user's size.

Similarly, in one embodiment, shopping component 142 can control device 102 to generate a user interface display 110 that displays the product on a body that has the same body type as the user, with the same proportions and measurements. Similarly, the product can be displayed on a video image of the user, as the user 108 stands in front of display device 102. If the user 108 decides to buy the product, the user can do so using a point system that is used by video game console 104, or using money, such as through a credit card transaction, etc. Additionally, if the user does not wish to buy the product, the user can simply save the product in the user's history 164 or preferences 162. Therefore, the next time that the user logs on to shopping component 142 and accesses shopping service 152, shopping component 142 can update the dashboard to show whether a product that was previously saved by the user has been discounted in price, whether it is currently available, etc.

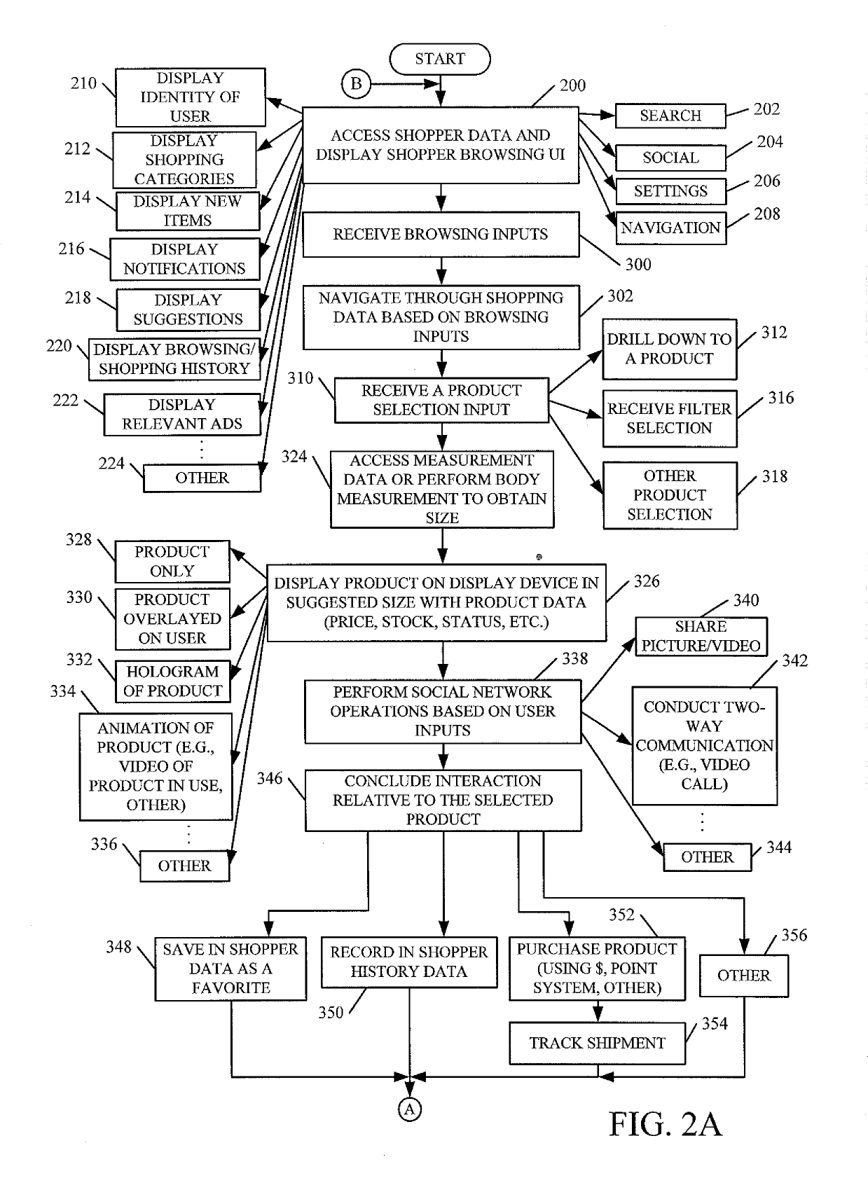

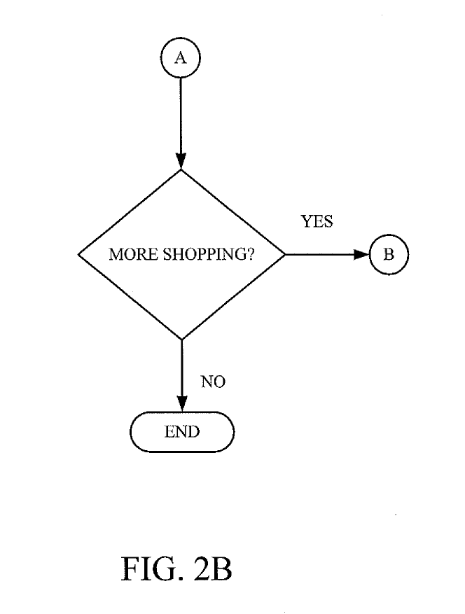

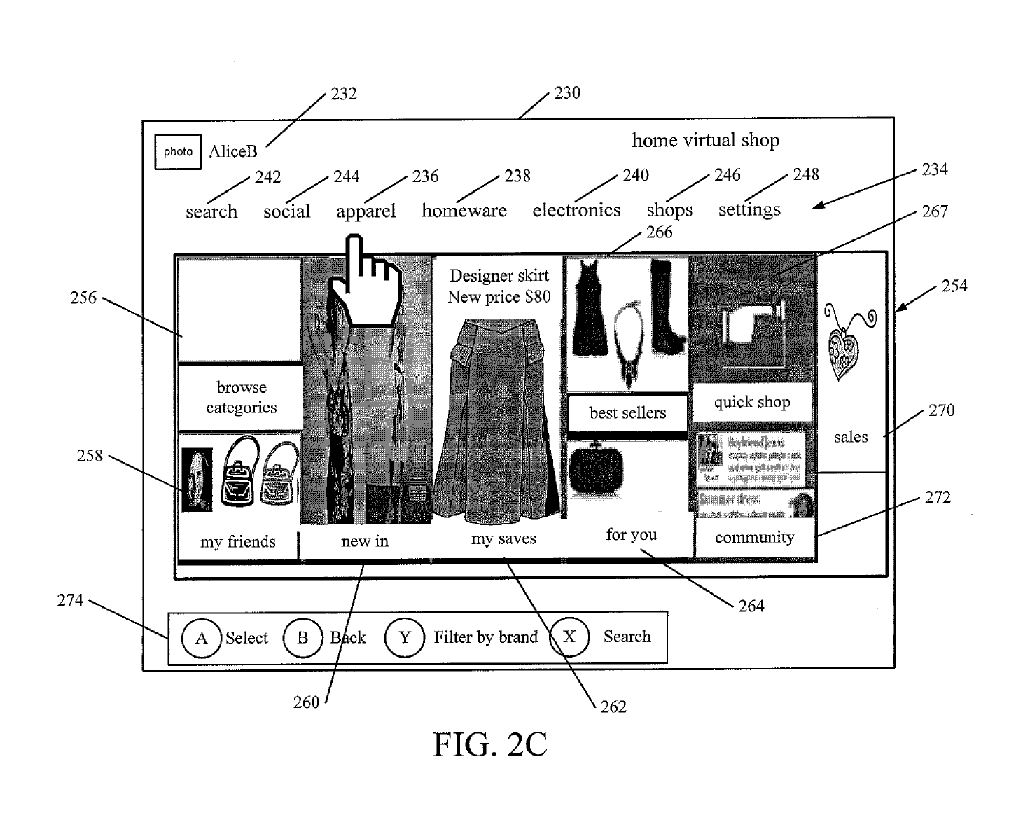

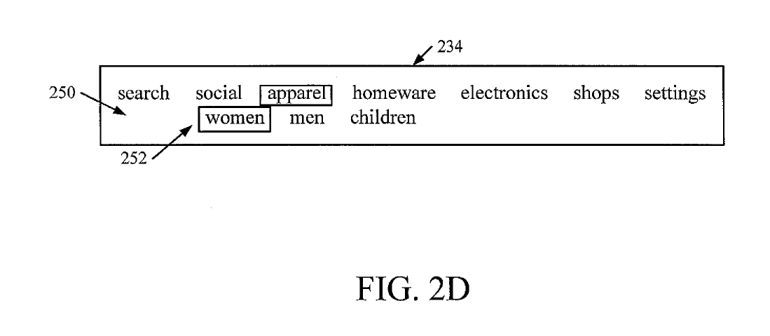

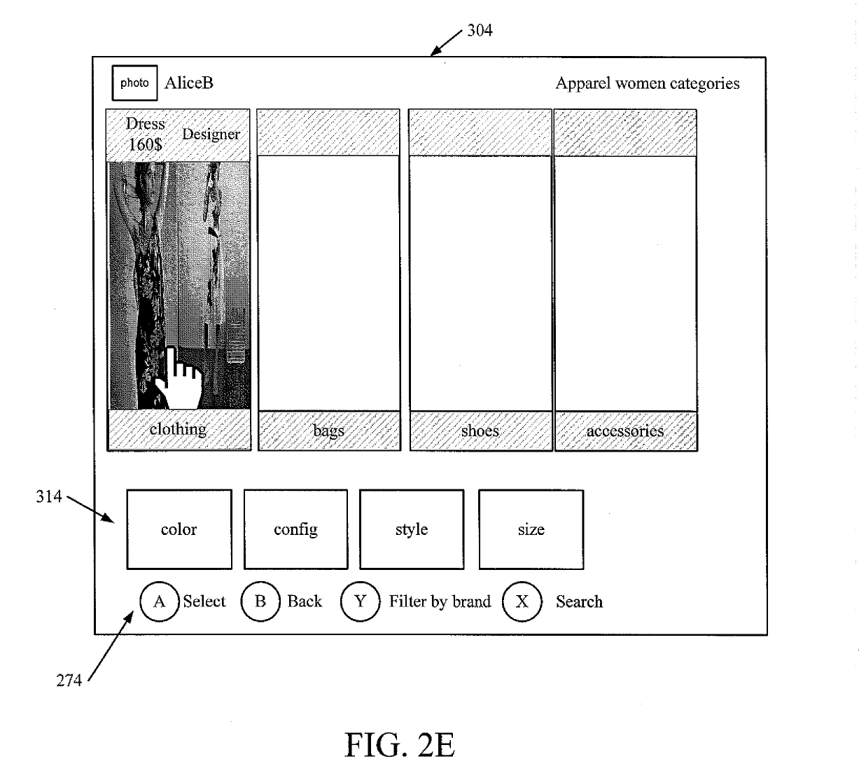

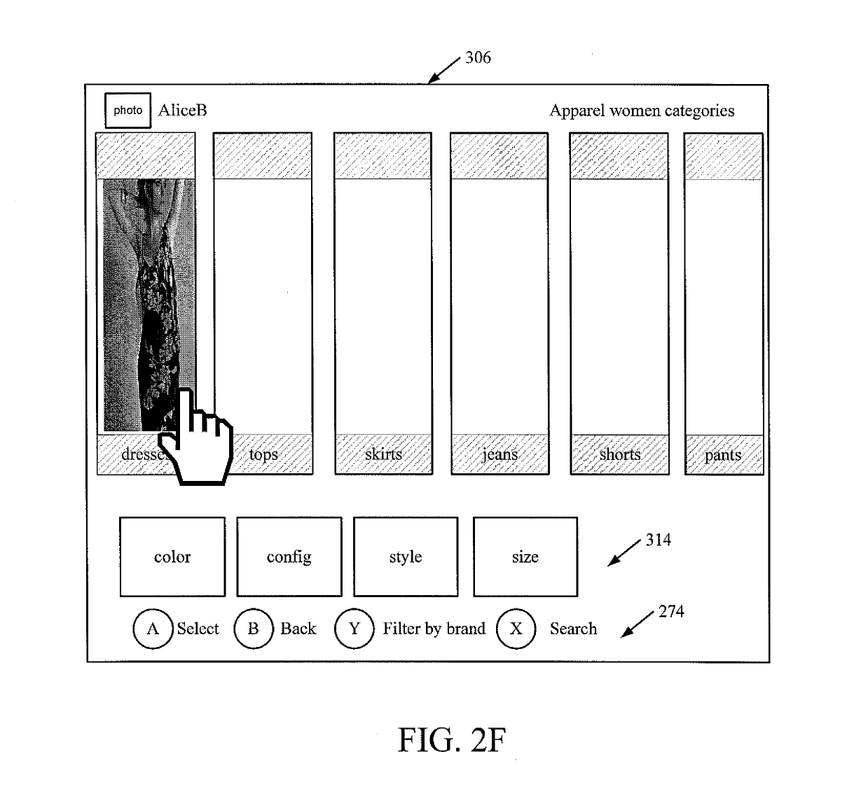

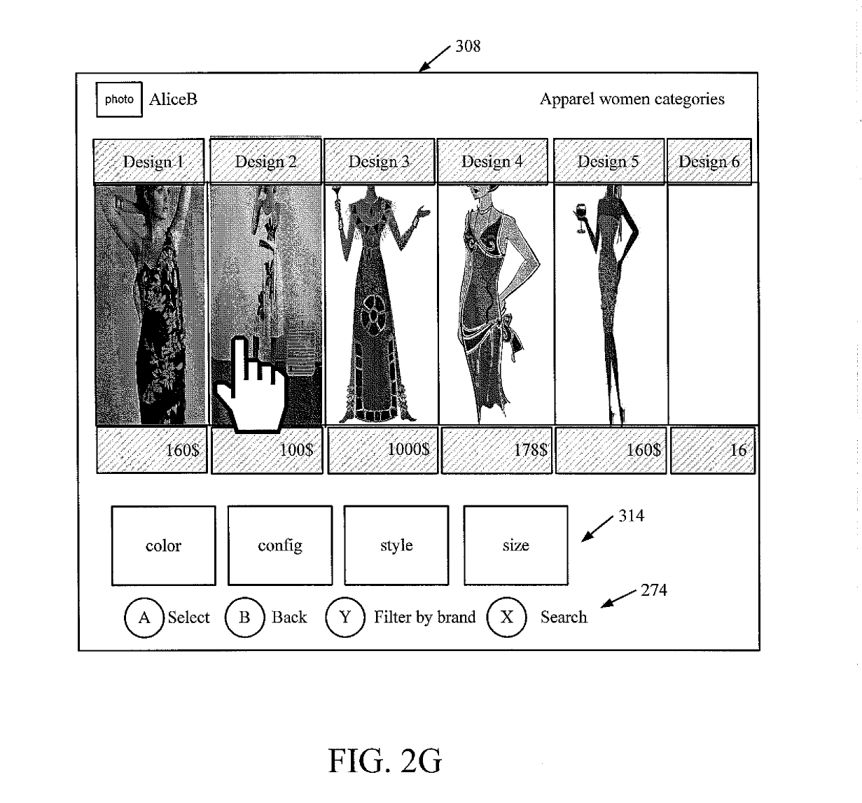

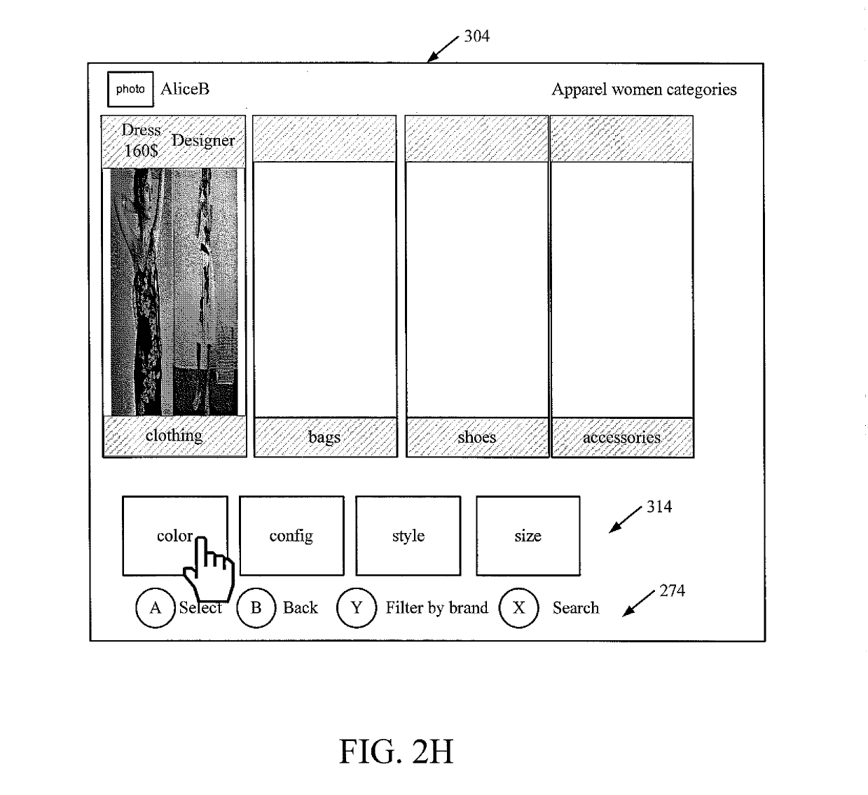

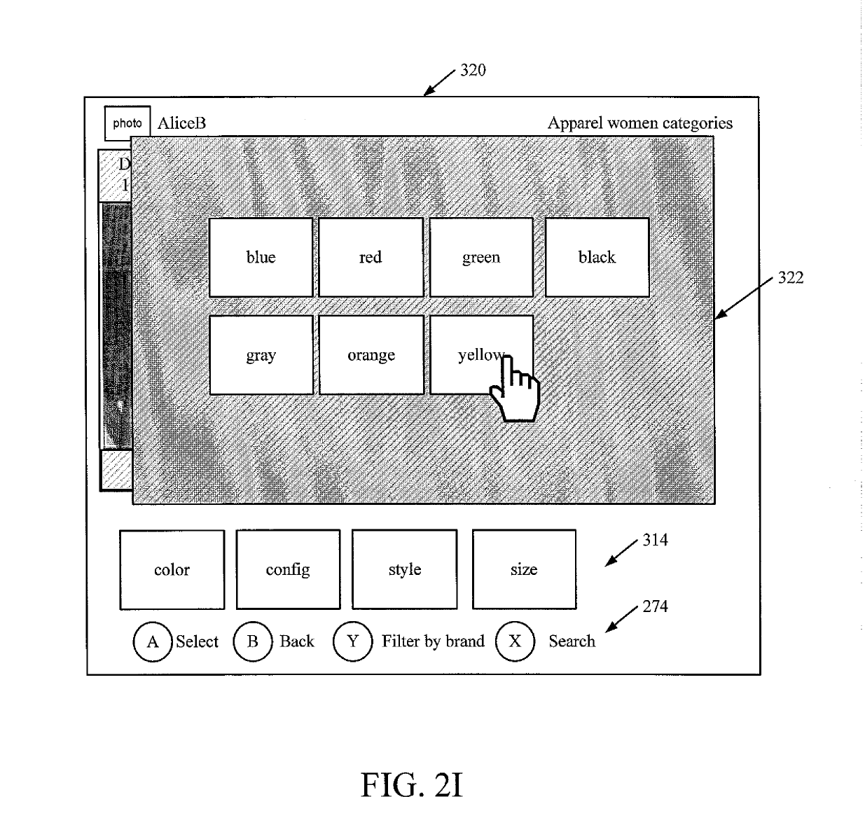

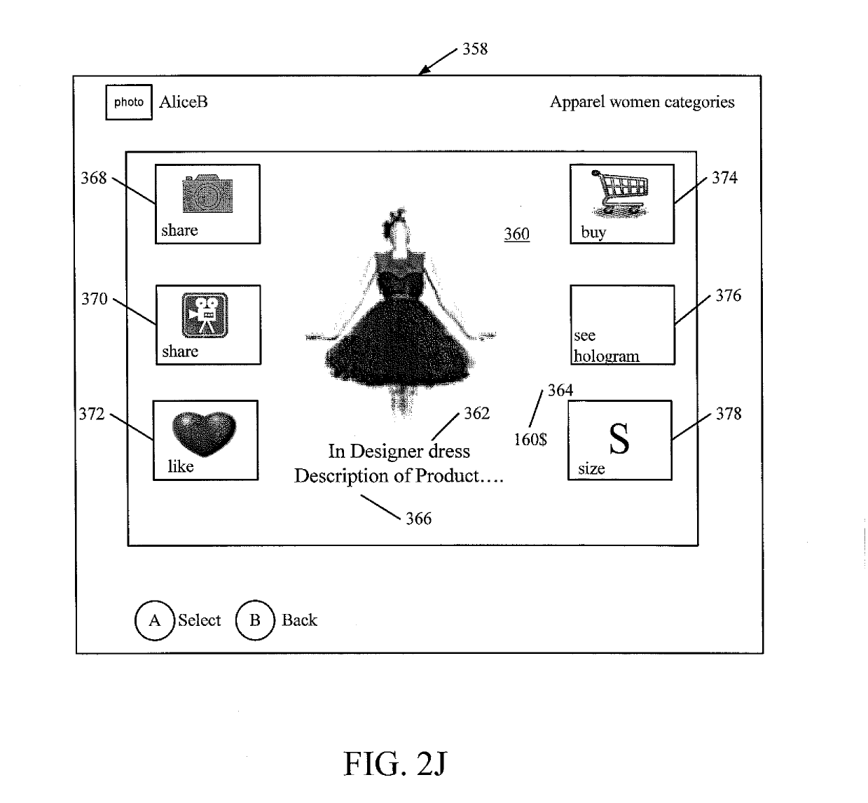

A more detailed description of the operation of system 100 in facilitating shopping services will now be described. FIGS. 2A and 2B (collectively referred to as FIG. 2). Show a flow diagram illustrating one embodiment of the operation of system 100 in performing shopping services, in more detail.

In one embodiment, after user 108 logs into the shopping system 100, shopping component 142 accesses shopping service 152 for shopper data and system 100 displays a shopper browsing user interface. Component 142 can access the data either locally from shopper data store 161 or remotely, from shopper data store 160. In either case, the shopper data illustratively includes the shopper preferences 162 and browsing or purchase history 164, shopper measurements 165 (which can be entered by the user in the user's profile information or measured as discussed below), other shopper data 167 among other things. The shopper browsing user interface can be displayed as a dashboard for the user, by dashboard component 140 and displayed as one of the user interface displays 110 on device 106.

In one embodiment, the browsing user interface allows the user to perform a search, to engage in social media, to set user settings (such as filters, what blogs to follow, preferences, etc.) and to perform various shopping navigation steps. Displaying the browsing user interface is indicated by block 200, searching is indicated by block 202, engaging in social media is indicated by block 204, setting user settings is indicated by block 206 and performing shopping navigation is indicated by block 208. In addition to these functions, the browsing user interface (or dashboard) can display the identity of user 108, as indicated by block 210. It can also display shopping categories 212, new items that may be of interest to the user (that can optionally be selected based on the user's history or preferences, but which can also display new items in categories or subcategories selected by the user as described below) as indicated by block 214, notifications as indicated by block 216, buying suggestions as indicated by block 218, browsing and shopping history as indicated by block 220, relevant advertisements as indicated by block 222, and other information as indicated by block 224.

The identity of the user may be obtained based on the user's login information and the shopper data from data store 160 or 161. Shopping categories can be based on user preferences or history or they can be default categories that are displayed to every user. New items suggested to the user can be identified by shopping component 142 through shopping service 152. That is, based upon the user preferences, and the user purchasing and browsing history, component 142 can identify certain product categories that are likely of interest to the user. In another embodiment, the new items are not based on history and preferences. Instead, they can be new items added today or this week or this month or since the user's last visit in the category or subcategory the user selected (described below). Component 142 can access those categories through shopping service 152.

Shopping service 152 provides an interface by which retailers 154, manufacturers 156 and other sellers 158 can register with, or subscribe to, shopping service 152. Shopping service 152 then aggregates product information, sales information, coupon information, special offering information, etc. from the sellers that have subscribed to it. This information can be stored locally with the retailers 154, manufacturers 156 or other sellers 158, or it can be aggregated and stored with shopping service 152 or in another location. In any case, based upon the user's preferences and purchasing and browsing history, shopping service 152 can provide shopping component 142 with shopping categories (or product categories) 212 and new items that may be of interest to the user 214.

Shopping component 142 can also display notifications 216, based upon the shopper data. For instance, the shopper can request to be notified of certain things, such as whether a given product becomes in stock, whether it is put on sale, or whether items in a certain category have been added. Of course, the shopper can desire notifications for other reasons as well, and these are only examples. Similarly, shopping component 142 can identify notifications, itself, which can be displayed to user 108 on the dashboard of user 108. For instance, based upon the shopping history of user 108, component 142 can identify related products that have just gone on sale. In that case, shopping component 142 can, itself, generate a notification for display to user 108. Notifications can be generated in other ways as well.

Suggestions 218 can be displayed, also based on shopper data, shopper preferences, and historical information. The suggestions or other items displayed to user 108 on the user's dashboard can be based upon the social media contacts or other media components that user 108 interacts with. For instance, if the user has a number of friends (on one or more social networks) that have all purchased a given item, shopping component 142 can suggest that item to user 108, as a suggestion, based upon the fact that the users in the social network of user 108 have purchased the item.

Component 142 can also display a button or other mechanism that allows user 108 to view the user's browsing or shopping history. This can be stored from previous sessions and aggregated, or it can be from only the most recent sessions, or other information can be used as well.

Component 142 can identify relevant advertisements 222 for display to user 108 as well. Again, this can be based on the user's interests as identified by the user's shopping or browsing history, or by the interests of those in the user's social network, or by the explicit expression that the user is interested in something. The sellers illustratively provide advertisements to shopping service 152. Shopping service 152 matches the subject matter of the advertisement against the interest of the user and identifies relevant advertisements in this way. Other ways of identifying relevant advertisements for display to user 108 can be used as well.

FIG. 2C shows one embodiment of a user interface display 230 that can be displayed to user 208, by shopping component 142 (which itself uses user interface component 138 and display device 106). User interface display 230 is one illustrative dashboard or home virtual shop screen that is displayed to user 208. In one embodiment, the user interface items on display 230 can be controlled by one or more of a variety of user input mechanisms. For example, where the display screen is touch sensitive, or where touch sensors are provided, user 108 can control the display elements on display 230 by touch gestures. Where natural user interface 130 is provided, the user can control the user interface elements on display 230 using touchless movements, using voice or speech recognition, etc. Similarly, in one embodiment, user 108 can control the user interface components using game controller 114, keyboard 116, or other user input mechanisms.

User interface display 230 shows a number of items. For example, a user identity 232 can be displayed. In this case, when user 108 logs into the shopping system 100, the user identity can be obtained from shopper data and displayed. User identity 232 can provide the identity in text, along with an optional picture or other images.

User interface display 230 also includes a first tab menu 234. Tab menu 234 displays a first level 250 of categories and functions that can be performed. For instance, tab menu 234 includes apparel category 236, homeware category 238, and electronics category 240. These are some of the categories that are offered by shopping service 152 for retailers 154, manufacturers 156 or other sellers 158 to choose from in registering with shopping service 152. Thus, during or after registration, the sellers place their products within these categories.

The functions provided in tab menu 234 include a search function 242 that allows the user to perform a search, a social function 244 that allows the user to engage in social networking on a social network or to engage in social shopping on a social network channel related to shopping, a shops function 246 that allows the user to navigate to a specific shop dashboard, and a settings function 248 that allows the user to set various settings and preferences.

In one embodiment, there are multiple levels within tab menu 234. FIG. 2D shows one example of a tab menu 234 with multiple levels. It can be seen that tab menu 234 has the first level 250 described above. However, once one of the tab menu selections has been made in menu 250, that determines what tabs will be displayed on a second level 252. In the example shown in FIG. 2D, the “apparel” category 236 has been selected. This causes the second level 252 to be displayed. It can be seen in FIG. 2D that the “women” subcategory has been selected within the “apparel” category. As is discussed below with respect to FIGS. 2E-2J, this allows the user to drill down to a specific product.

Referring again to FIG. 2C, search tab 242 directs the user to a search screen where free text searching can be performed. This can be used to look for any product across all categories, across any individual category, across any retailers, across any brands, colors, etc.

Social tab 244 allows the user to access a social shopping network or other social network. It directs the user to a user interface screen that shows shopping activities of all of the user's friends. Postings showing reviews or products that the user's friends bought can be viewed and shared or saved. Posts related to shopping, fashion or other posts can be reviewed and saved as well.

The shops tab 246 connects the user to a user interface display on which an individual shop can be chosen and products for that shop are displayed. The shop can be customized by the seller or the seller can use a default shop template. One example of a default shop template provides an interface such as the one shown in FIG. 2C, but filtered to show only the specific seller's products.

Settings tab 248 navigates the user to a user interface display on which several preferences can be set up. The preferences can be any of a wide variety of different preferences. Some exemplary preferences allow the user to set a list of friends, to set up shortcuts that take the user to desired shops, to predefine searches that can be quickly actuated and launched by the user, to set community preferences that are preferences of the user's community of friends or social connections on a social network, to set the amount of time that saved items are to be saved, before they are removed from the shopper data, etc. Of course, these are only exemplary settings and additional or different ones can be used as well.

User interface display 230 of FIG. 2C also includes a main content portion 254. The main content portion 254 shown in FIG. 2C is exemplary only and includes browse categories tile 256, my friends tile 258, new in tile 260, my saved tile 262, for you tile 264, best sellers tile 266, quick shop tile 268, sales tile 270 and community tile 272. Of course, other tiles can be used in main content portion 254 as well and those listed are exemplary only. Also, it will be appreciated that the tiles shown in main content portion 254 are arranged in only one exemplary way as well. They can, of course, be arranged differently. For instance, as shown in FIG. 2C, the tiles can be split in two-to-three vertical sections to display text and pictures or other images. The pictures or images that are displayed can be refreshed on a second-by-second basis, or on any other periodic basis. Or, they can be refreshed only when necessary, such as when changes are made to the underlying content represented by the tile. In addition, contextual text (the text that is bound to the picture or image) can be updated as well.

In the embodiment shown in FIG. 2C, browse categories tile 256 allows the user to navigate to the subcategories of the selected upper menu categories. For example, actuating the browse categories tile 256 shows the subcategories for the apparel category, if the apparel tab was selected in the top navigation tab section 234. It shows subcategories for the apparel/women subcategory if those tabs are selected.

My friends tile 258 shows the picture or image associated with a friend of user 108 and a number of other pictures or images of items the particular friend is browsing or buying. The tile 258 can be refreshed periodically. When the tile is pressed, clicked on, or otherwise actuated, it directs user 108 to a user interface display that shows the particular products that the friends of user 108 are browsing, saving for later, buying (if they choose to make that public), or otherwise interacting with. This can also show the user pictures or videos (or both) of the user's friends who are sharing what they are wearing today, what they are trying at the moment, etc. Content of tile 258 and the drill through screen which shows what the friends are browsing, saving, buying, etc., is contextual to the selected upper category. That is, it changes based on changes in the selected upper category. For example, if apparel is selected in the upper category, tile 258 shows the friends of user 108 with shopping activity related to apparel items only. Of course, this can be changed to be general, instead of contextual, or contextual to selected subcategories as well.

New in tile 260 shows pictures or images of new products that have recently been added by sellers. It also shows information about the brand and price (in one embodiment in the upper part of the tile). The tile 260 can refresh periodically (such as every second) and other product information can slide into the tile to show another new product. If pressed, or otherwise actuated, the tile 260 directs the user to a user interface screen with a list of new products. The list can be horizontal, vertical, or oriented in another direction. The tile 260 and the corresponding list screen can also be contextual in that the context of the selected category (and subcategory) determines what particular products are shown. That is, by way of example, if apparel is selected, then tile 260 shows new apparel products.

My saved tile 262 shows pictures or images of saved products (that user 108 has previously saved in his or her shopper data) and information about updated product characteristics. The characteristics can be a wide variety of different characteristics. In one embodiment, the characteristics include price, whether the product is new in stock, out of stock, whether a new color is in stock, whether specific colors are out of stock, etc. It can refresh periodically, such as every second. When the update occurs, another product slides into the tile. If the tile is pressed or otherwise actuated, it directs user 108 to a user interface display with a list of all saved products for user 108, and the corresponding information about those products. This list can be arranged horizontally, vertically, etc. The tile and the list screen are illustratively contextual to the selected category or subcategory.

The for you tile 264 shows pictures or images of products that are suggestions for user 108. In one embodiment, three or more pictures are displayed at a time. Of course, that number can vary as well. Tile 264 also refreshes and, when actuated, directs the user to a list of other suggested products. It is also contextual and applies to the category or subcategory that is selected. The suggested items can be computed by using component 142 based on a wide variety of different criteria. In one embodiment, the products that are shown in tile 264 are identified by shopping component 142 based on user-defined preferences in the settings panel corresponding to user 108. Other criteria can include viewing and buying history 108, and various blogs that have been visited or identified by user 108 through social network service 170. The suggested products can be identified based on other criteria as well, and these are listed for the sake of example only.

Best sellers tile 266 shows pictures or images of products that are best selling products for the various sellers that use service 152. In one embodiment, a plurality of pictures can be shown on a single tile 266. The tile refreshes intermittently and, if actuated, it directs the user to a user interface display with a list of all of the best selling products and information about those products. The tile and the list are contextual to the selected category or subcategory, in one embodiment, as well.

Tile 270 shows pictures of products that are on sale, or otherwise discounted. In one embodiment, tile 270 can show a plurality of different products (such as two-three products or a different number) in a single tile. The tile can refresh intermittently to show other products, and it can also be contextual. When tile 270 is actuated, it directs the user to a list of products that are on sale. Tile 270, and the corresponding list view, can also illustratively be contextual to the selected category or subcategory.

Quick shop tile 268, when actuated, directs the user to a user interface display showing a list of products that are already filtered based on filters set by the user. For instance, the user 108 can illustratively set filters in the shopper data for user 108 that filter products shown after actuation of the quick shop tile 268 based on product dimensions, such as size, color, etc. However, the products listed in the quick shop list can also be filtered based on categories, subcategories, or other filter criteria that the user sets up in his or her preferences 262 in the shopper data store 160 or 161.

Community tile 272 displays the information for a social network of user 108 or blogs. In one embodiment, community tile 272 displays the latest blog posts on blogs that are identified based on the preferences 162 of user 108. The blogs to be scanned can also be set up by user 108 in his or her settings panel. There can also be default blogs to be scanned if no preferences are set up by the users. The default blogs can be identified based on the category or subcategory that is selected and based on an automatic search and match algorithm applied to determine which blogs to monitor. The search and match algorithm can consider the user's browsing or purchasing history 164 or other shopper data corresponding to user 108, or it can be a general search and match algorithm that applies regardless of the user's specific information. Tile 272 illustratively displays information to which the blog entry belongs. For instance, the tile 272 can display a picture or image of the blogger, the title of the blog post and its first sentence or abstract. If actuated, tile 272 directs the user to a user interface display screen with a list of all the blog posts for that particular blog. Of course, the list can be a continuous horizontal list, a vertical list, or another type of list.

Exemplary user interface display 230 shown in FIG. 2C also includes a set of navigation controls 274. The navigation controls 274 illustratively include “Select”, “Back”, “Filter by Brand” and “Search”. These navigation controls are illustratively the same as the navigation controls for game controller 114 that is used with game console 104. Where natural user interface 130 is included, these controls can be actuated by voice command, keyboard command, touchless or touch gestures, etc. Controls allow user 108 to select an item, go back to a previous screen, filter the displayed items by brand, or conduct searching.

After dashboard component 140 or shopping component 142 displays the user interface display 230 shown in FIG. 2C, or another user interface display, shopping component 142 can receive browsing inputs from user 108, through user interface display 230. This is indicated by block 300 shown in FIG. 2. Browsing inputs illustratively involve user 108 selecting and actuating various tiles or tabs or buttons on user interface display 230 to navigate to a desired place. For instance, where the user selects the top categories and subcategories as the apparel category and women subcategory, the user can select the browse categories tile 256 and be directed to the browsing interfaces for browsing products in the selected categories and subcategories. The inputs allow user 108 to navigate through the shopping data based on the browsing inputs. This is indicated by block 302 in FIG. 2.

For instance, when user 108 actuates the browse category tile 256, dashboard component 140 or shopping component 142 (using user interface component 138), generates a user interface display showing the list of subcategories for apparel/women. One embodiment of this is user interface display 304 shown in FIG. 2E. User interface display 304 shows that, for each selected category and subcategory, there is yet another level of subcategories. For instance, under the apparel/women category and subcategories, there is yet another level of categories that includes “clothing”, “bags”, “shoes”, “accessories”. For each subcategory in this third level of subcategories, a tile is displayed with the name of the third level subcategory, along with a picture or other image or other information about a product from that subcategory. The picture and product information can refresh intermittently after any desirable about of time, so that each tile cycles through multiple different products corresponding to the third level subcategory identified in that tile.

In one embodiment, the user can then drill down even further from these third level subcategories into more subcategories. FIG. 2F is one illustrative user interface display 306 which shows this. In the embodiment shown in FIG. 2F, the user has actuated the clothing tile in user interface display 304 in FIG. 2E. This causes user interface display 306 to display yet another level of subcategories that includes “dresses”, “tops”, “skirts”, “jeans”, “shorts”, “pants”, etc.

After the user has drilled down through all necessary levels of subcategories, shopping component 142 or dashboard component 140 generates a user interface display that shows a set of tiles with the products in the ultimate, selected subcategory. FIG. 2G shows one embodiment of a user interface display 308 that illustrates this. FIG. 2G shows that the user has selected the “dresses” subcategory from user interface display 306 in FIG. 2F. Therefore, user interface display 308 shows a plurality of tiles, each of which has a dress on the tile. In the embodiment shown, the tiles represent a list of products, and each tile includes information about the product displayed on that tile, such as the brand, the price, a picture or other representation of the product, etc. by actuating a tile, the user can select a specific product in this way. Using a product selection input through which the user selects a specific product is indicated by block 310 in FIG. 2.

User 108, as discussed above, can select a product by drilling down to a product through the categories and subcategories to reach an ultimate product. This is indicated by block 312 in FIG. 2. However, the user can do this in other ways as well. For instance, before selecting a product, the user can filter the list of products shown in user interface display 308 across a variety of different product dimensions. In user interface display 308, the product dimensions are shown in product dimension list 314 which appears below the set of tiles displaying the products. FIG. 2G shows that the list of product dimensions that can be used as filter criteria includes “color”, “configuration”, “style”, and “size”. Of course, these are exemplary product dimensions and others could be used as well. When user 108 activates one of the tabs in list 314, shopping component 142 filters the products displayed in user interface display 308 based on the product dimension selected from list 314. Receiving a filter selection and filtering the displayed products based on the filter selection is indicated by block 316 in FIG. 2, and selecting a product in a different way, other than that described, is indicated by block 318 in FIG. 2.

Before continuing with the description as to how a user can select a particular size for an item, it should be noted that the filters in filter list 314 can be applied at other levels, such as other categories and subcategories, instead of just the product subcategories shown in FIG. 2G. For instance, FIG. 2E shows that the filter list 314 can be displayed when the apparel/women category and subcategory are chosen.

In addition, when user 108 selects one of the tiles in list 314, shopping component 142 illustratively generates a user interface display that allows the user to select a specific parameter from the selected filter tile. For instance, FIG. 2H shows that, when the user 108 has selected the color filter in list 314, another user interface display 320 is displayed with a plurality of different colors that the user can select from, in a selectable list of tiles 322. In the embodiment shown in FIG. 2H, list 322 shows seven different colors, each corresponding to a different tile. When the user selects the “yellow” tile, shopping component 142 filters the display 304 to show only yellow products. In one embodiment, the user can select multiple different tiles from list 322 so that different combinations of colors can be selected.

The same will happen if the user selects the “configuration” tile or the “style” tile from list 314. That is, a user interface display (like list 322) will be generated with a plurality of different product configurations to select from, or product styles to select from, respectively, and shopping component 142 will filter the displayed products based on those filter inputs.

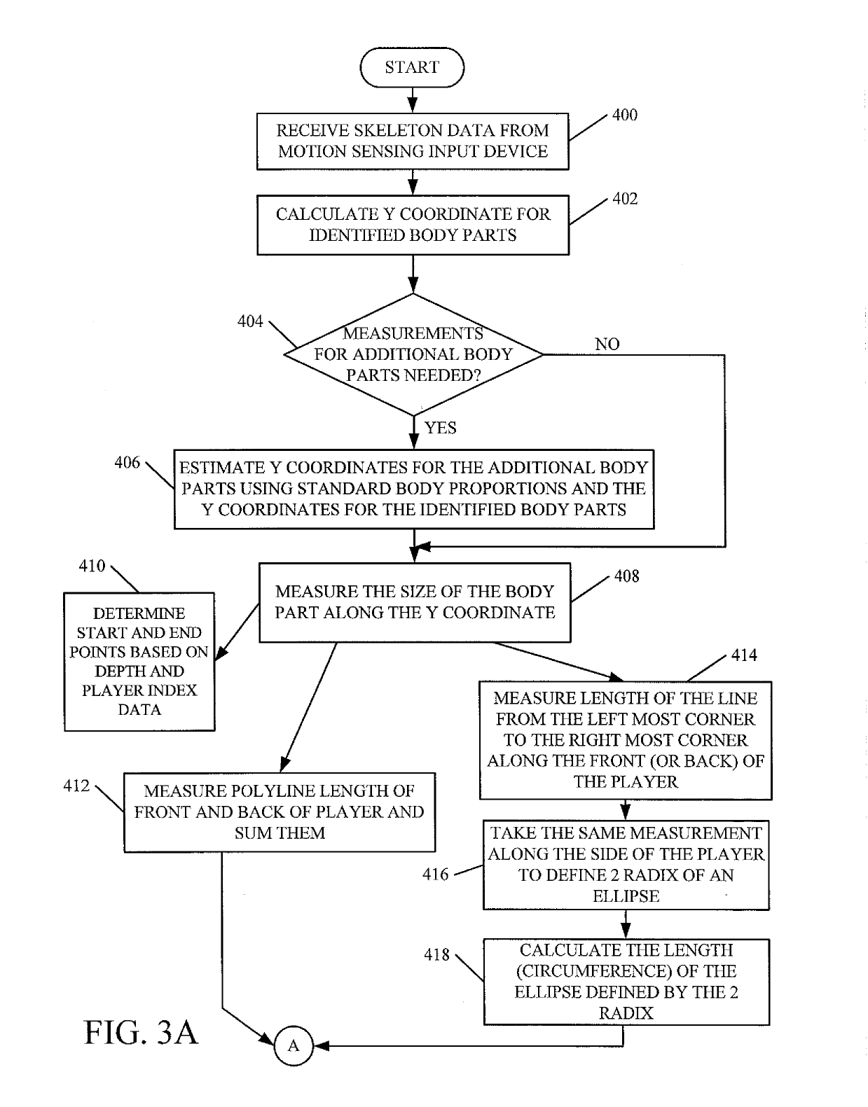

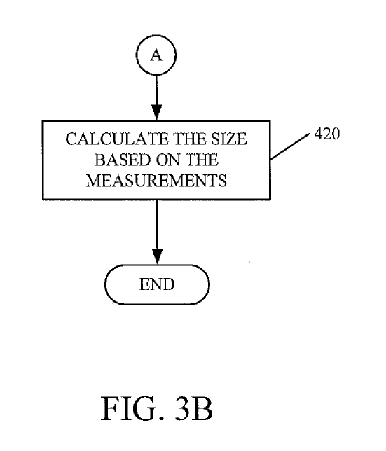

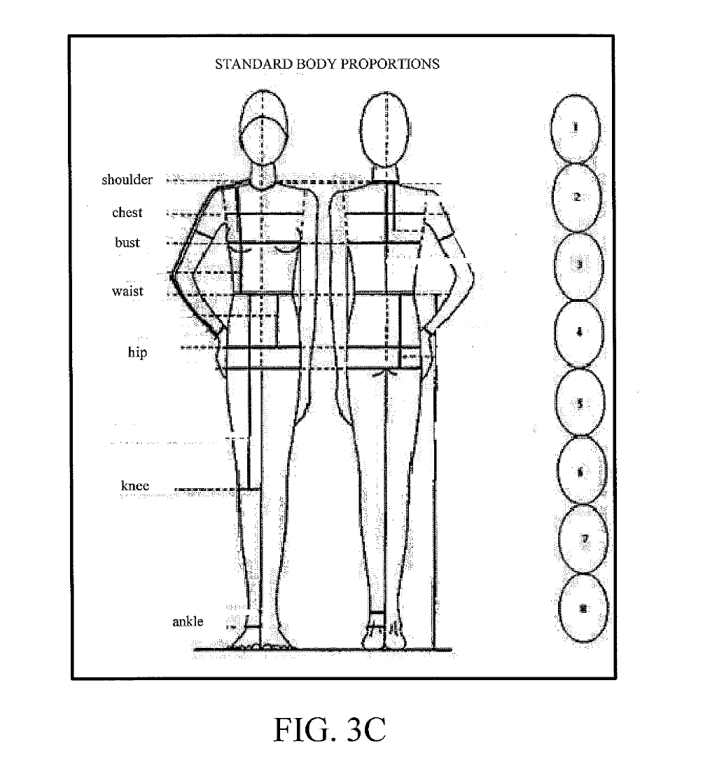

If the size criteria is chosen from list 314, then a user interface display is generated that includes a “my size” tile. When the “my size” tile is selected, then shopping component 142 can access shopper data for this particular user 108 to see if a size has already been measured for user 108. If not, then this measurement can be performed to obtain the size for the body of user 108. This is indicated by block 324 in FIG. 2. One way system 100 can take measurements to obtain a size is discussed in greater detail below with respect to FIGS. 3A and 3B. Suffice it to say, for now, that system 100 obtains a size for the body of user 108. When the size has been obtained, shopping component 142 generates a user interface display that displays the product on display device 106 in the suggested size (suggested for user 108) with product data, such as price, whether the product is in stock, available colors, or other information corresponding to the product. This is indicated by block 326 in FIG. 2.

The product can be displayed in a number of different ways. For example, the user interface display can simply show a picture or other image of the product. This is indicated by block 328. In addition, the display can show a picture of the product displayed on the user's body, based upon the measurements taken and the size of the user. This is indicated by block 330 in FIG. 2. In another embodiment, a hologram of the product can be generated in the room or other space where user 108 is using system 100. This is indicated by block 332. Shopping component 142 can also use natural user interface 130 on device 102 to generate an animation of the product, such as a video of the product in use, a video of various views of the product, etc. These videos can be made available by the sellers or other persons. This is indicated by block 334. Of course, the product can be displayed in other ways as well, and this is indicated by block 336.

The user interface display that shows the product can also provide user input mechanisms that allow user 108 to perform social network operations based on those user inputs. This is indicated by block 338 in FIG. 2. For instance, the user can share a picture or video of the selected product with his or her connections on a social network. This is indicated by block 340. User 108 can also illustratively conduct two-way communications (such as a video call or other two-way communications) with another person over social network service 170. This is indicated by block 342. The user can, of course, perform other social network operations (such as liking the product on a social network, following the product, etc.) and these other operations are indicated by block 344.

The user eventually concludes his or her interaction relative to the selected product. This is indicated by block 246. In doing so, the user can illustratively save the product in the shopper data for user 108, as a favorite. This is indicated by block 348. System 100 can also record the user's interaction in the shopper history data for user 108. This is indicated by block 350. The user can purchase the product using money or a point system as indicated by block 352 and the user can also track shipment of a purchased product as indicated by block 354. Similarly, the user can perform other operations as indicated by block 356.

FIG. 21 shows one embodiment of a user interface display 358 used to perform some of these operations for a selected product. It can be seen in block 358 that the user interface display includes a product pane 360 that shows the product, either by itself or overlaid on the user's body in the user's size and selected color. Pane 360 also illustratively includes a textual identifier for the selected product, such as the brand and the name of the product, as indicated by block 362. The pane 360 can also include pricing information 364 and other descriptive information 366 that corresponds to the selected product. This can include reviews of the products by others with reviews coming from friends, highlighted, and information indicating how friends have interacted with this product (such as viewing it, liking it, saving it, etc.).

User interface display 358 also includes a share picture tile 368, a share animation (or share video) tile 370, a like tile 372, a buy tile 374, a see hologram tile 376 and a size tile 378. Share picture tile 368 provides an option to share one or more pictures of the selected product over the social shopping network (or other social network) though social network service 170 directly with an on-line friend. If the friend is off-line, user 108 is illustratively the picture given the option to send by mail or text message or, if by other mechanisms. The picture can be of the product or motion capture component 132 is provided, it can be of the product overlaid on the user's image. Share video tile 370, when actuated, provides a user interface display that enables user 108 to generate or download a video and to share a video of the product (e.g., one where the product is overlaid over the user's body) through the social network, directly with a friend, or otherwise (such as sharing it with a group or posting it for a more general audience).

Tile 372 allows the user to save the product for later and to be notified of updates on the product (such as whether it is in stock, on sale, etc.). Tile 374 navigates the user to a user interface display that adds the product to a shopping basket which can then be paid for using a common payment system. This allows the user to actually purchase the product. See hologram tile 376 causes motion sensing touchless input device 102, to generate a hologram of the product using its actual product dimensions in the user's own living room or wherever else system 100 is deployed.

Size tile 378 navigates user 108 to a user interface display that allows the user to select a desired size. The size of the user will automatically be suggested on tile 378. However, if measurements of user 108 have not yet been taken, then tile 378 will not display a suggested size, but a message indicating that a measurement needs to be taken, or a size selected.

After the user has completed his or her interaction relative to the selected product, system 100 determines whether the user would like to conduct more shopping. This can be done by simply asking the user to continue shopping, to check out, to signoff, etc. Determining whether more shopping is to take place is indicated by 380 in FIG. 2. If so, processing continues at block 200 in FIG. 2. If not, then this shopping session has been completed.

FIGS. 3A and 3B (collectively referred to as FIG. 3) show a flow diagram illustrating one embodiment of the operation of system 100 in performing a size measurement for user 108. In one embodiment, motion sensing touchless input device 120 can be used to identify certain joints in the body of user 108. For instance, in order to detect and track input gestures from the user 108 moving his or her body, system 100 identifies (or retrieves from shopper data) skeleton data for user 108 as discussed above. Rotation of the joints can be detected in terms of x, y and z coordinates.

In order to measure the size of user 108, component 142 illustratively first receives skeleton data either stored for user 108, or by obtaining it from motion sensing touchless input device 120. This is indicated by block 400 in FIG. 3. Component 132 then illustratively calculates a y coordinate for each of the body part for which a measurement is needed, as indicated by block 402. The y coordinate is the vertical distance from the floor to the given body part. Skeleton data may not provide joints or identifiers for all of the parts that need to be measured for a given product. In that case, standard body proportions, and the closest joints (or other body parts) that are provided in the skeleton data, are used to estimate the y coordinate of the additional body part that needs to be measured. Determining whether additional body parts need to be measured (other than those for which skeleton data already exists) is indicated by block 404 and estimating the y coordinates for those body parts using standard body proportions is indicated by block 406.

For instance, the y coordinate of the hip joint of the body of user 108 is the distance from the ground to the user's hip. If the hip joint is provided in the skeleton data for user 108, then the skeleton data will be used directly, to obtain the measurement. However, in order to determine the height of the user's chest above the floor (i.e., in order to determine the y coordinate of the user's chest) standard body proportions may be needed. For instance, if the skeleton data provides the y coordinate for the hip joint and the shoulder joint, but not the chest, then standard body proportions provide that the chest is ⅓ of the distance between the shoulder and hip joints when measuring from the shoulder joint toward the hip joint. As another example, if the y coordinate for the waist is not part of the skeleton data, then standard body proportions indicate that the y coordinate of the waist is ¼ of the distance between the shoulder joint and the hip joint, when measuring from the hip joint. Of course, standard body proportions can be used to obtain the y coordinate for other body parts as well.

Once the y coordinates for the given body part have been obtained, then the size of the body part can be measured by measuring in the x direction (i.e., the horizontal direction) along the y coordinate. This is indicated by block 408 in FIG. 3. For instance, FIG. 3D shows that a number of measurements can be taken along the y coordinate for the user facing toward sensing device 102 and away from device 102. This can be done in a number of different ways, two of which are described below. In any case, the starting and ending points for taking the measurement of a body part along the y coordinate are based on depth data and player index data. For instance, depth sensor 128 can identify a first pixel that contains a pixel value corresponding to the presence of the body of user 108. Scanning from the left to the right across the player, when a player bit is encountered in the depth data (at the outer left side of the body where the measurement is being taken) this indicates that the measurements should start, because it is the first bit that indicates that the player's body is present. When no player bit is encountered (again while scanning in the x direction along the y coordinate) in the depth data, this means that the scan is at the outer right portion of the player's body. Therefore, the measurement ends at that point. Determining the start and end points for measuring along the y coordinate based on depth and player index data is indicated by block 410 in FIG. 3.

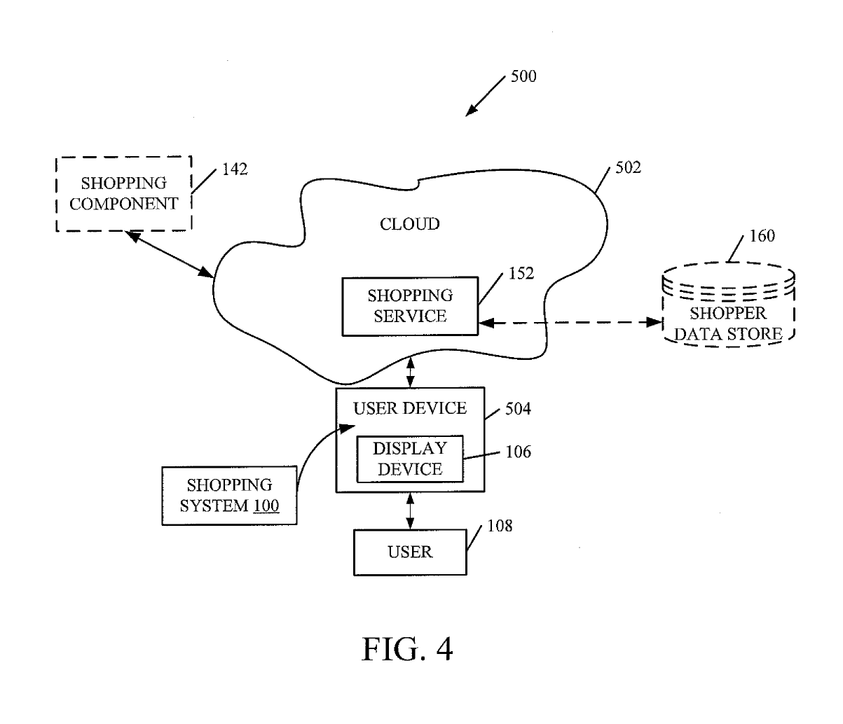

As mentioned above, the actual measurement can be performed in a number of different ways, although the starting and ending points can be identified as discussed above. In one embodiment, the polyline length of the front and back of the player are measured along the y coordinate. The polyline lengths are then summed to obtain the overall measurement to obtain the total size. For instance, shopping component 142 can generate a user interface display 110 that instructs user 108 to face motion sensing touchless input device 120. Component 142 can then control device 102 to take the measurement of the user's chest along the y coordinate. A user interface display can then be generated that instructs user 108 to turn around so that the user's back is facing device 120, and component 142 can control device 102 to measure the polyline length across the back of the user. The polyline lengths (along the front and the back) are then summed and this is used as the chest measurement. This is indicated by block 412 in FIG. 4. The measurement can also be optionally correlated to a size such as small, medium, large, etc.

In another embodiment, shopping component 142 controls device 102 to measure the length of the line from the left most corner to the right most corner along the front (or back) of user 108. This is indicated by block 414 in FIG. 3. The user is then instructed (such as through an appropriate user interface display) to turn sideways and the same measurement is taken along the side of the player. The two measurements (along the front or back of the player and along the side of the player) define two radix of an ellipse. The length (or circumference) of the ellipse is defined by the two radix, and this is calculated to obtain the overall measurement. Taking the measurements along the side of the player to define the two radix is defined by block 416 in FIG. 4, and calculating the length of the ellipse is indicated by block 418 in FIG. 3.

Once all of the appropriate measurements have been taken, then component 142 can perform needed transformations to calculate the size based on the measurements. This is indicated by block 420 in FIG. 3. In one embodiment, the measurements are all taken in terms of pixels, or pixel size. Equation 1 calculates the actual size from the measured pixel size using the following transformation:

Var actualWidth=(pixelWidth*actualDist)/((resolutionWidth/2.0)*(1/Math.Tan((FOV_MSID/2) (Math.Pi/180)))); Eq. 1

### Where:

actualWidth is the actual size in millimeters (same unit of measure as the Z distance)
pixelWidth is the measured width in pixels (in the depthData image)
actualDist (is the average Z distance which is the distance of the subject from the motion sensing input device)
resolutionWidth is the width in Pixels of the whole image. For the DepthAndPlayerindexlmage, this is 320 pixels.
FOV_MSID is motion sensing input device's Field of View (taken from the hardware specifications) in degrees.

It can thus be seen that system 100 provides shopping as a service over a home game console. The service is available to retailers and manufacturers or other sellers all over the world who can use a data entry interface to input their products into shopping service 152, for access by system 100. The products are then made available to end users through the shopping portal (e.g., shopping component 142) of the home console 104. With shopping console 104 and input device 102, users are able to control the interface of the shopping portal with motion sensing device 130. The users can also use a touch screen, a keyboard, voice, or a game controller, etc. Users are able to browse products across all retailers or sellers who have signed their products up with the shopping service 152. Based on their shopping, viewing, sharing, favorites, and other history, system 100 can suggest products for the user. Where the user looks to purchase an apparel product, the user is able to visualize a product image overlaid over his or her own body image on the display device 106. The users are able to share an image or a video of the product overlaid on their own body image with friends on multiple social networks provided by service 170. Users can also see a hologram, in real size. In addition, through motion sensing input device 120, the user's body measurements can be taken and a size is suggested for the user. Users are able to save products as favorites or mark them for buying later, and users are able to buy the products using a payment system that is provided by shopping service 152, so that it is common across all retailers, manufacturers or other sellers that have signed up for shopping service 152.

FIG. 4 is a block diagram of system 100, shown in various architectures, including cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

The embodiment shown in FIG. 4, specifically shows that shopping service 152 is located in cloud 502 (which can be public, private, or a combination where portions are public while others are private). Therefore, user 108 uses a user device 504, (which can include input device 108 and console 104) to access those systems through cloud 502.

FIG. 4 also depicts another embodiment of a cloud architecture. FIG. 4 shows that it is also contemplated that some elements of system 100 are disposed in cloud 502 while others are not. By way of example, data store 160 can be disposed outside of cloud 502, and accessed through cloud 502. In another embodiment, some or all of the components of system 100 are also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. FIG. 4 further shows that some or all of the portions of system 100 can be located on device 504. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

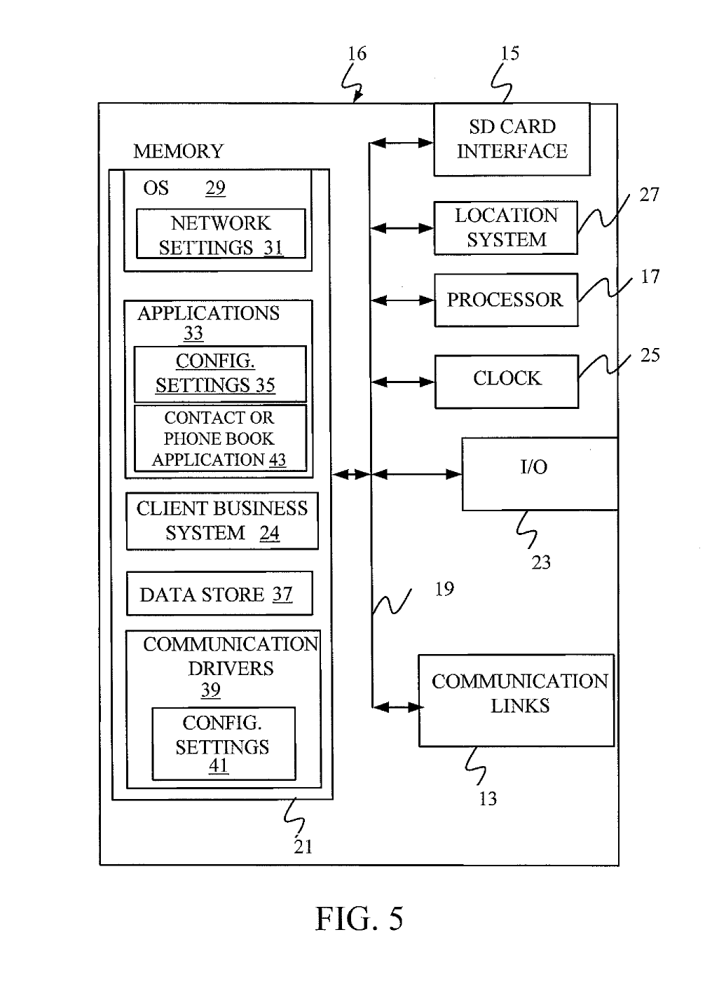

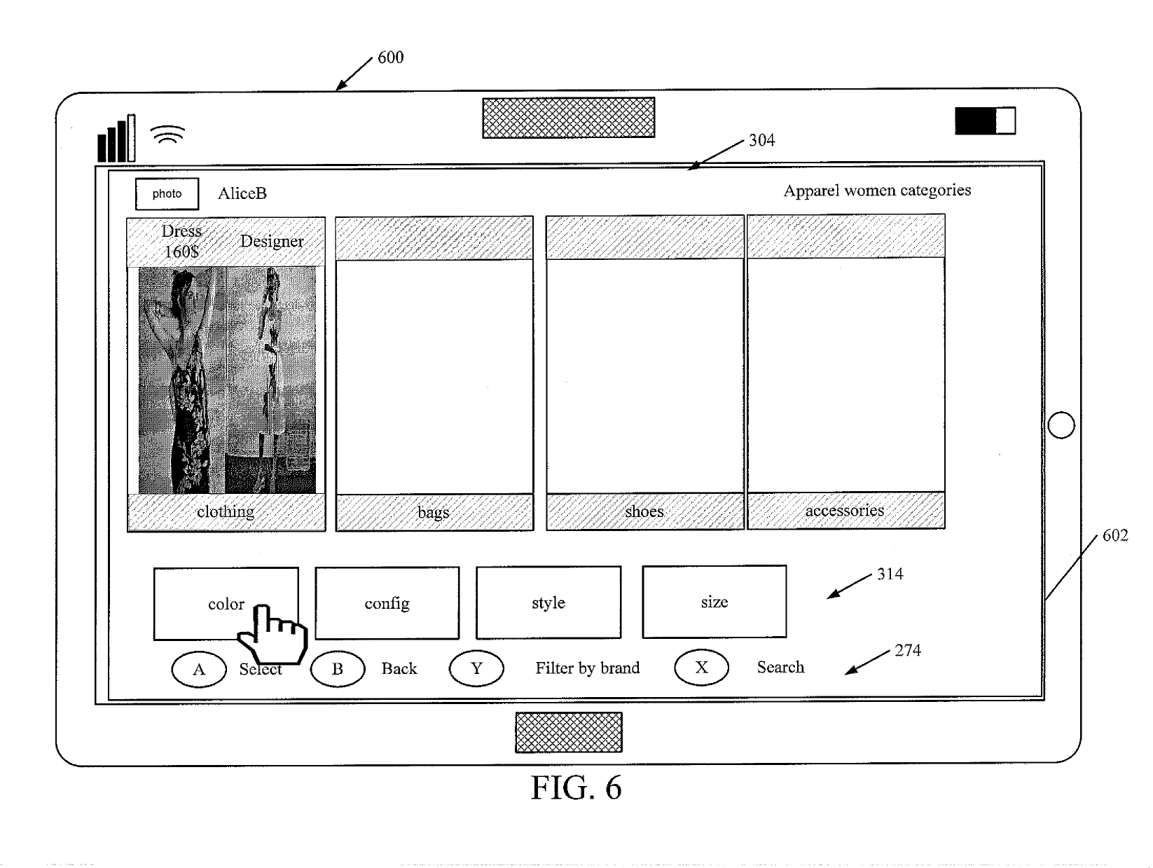

FIG. 5 is a simplified block diagram of one illustrative embodiment of a handheld or mobile computing device that can be used as a user's or client's hand held device 16, in which the present system (or parts of it) can be deployed. FIGS. 6-9 are examples of handheld or mobile devices.

FIG. 5 provides a general block diagram of the components of a client device 16 that can run components of system 100 or that interact with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 100) are received on a removable Secure Digital (SD) card that is connected to a SD card interface 15. SD card interface 15 and communication links 13 communicate with a processor 17 (which can also embody processors 112 and 146 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. System 100 or the items in data store 160 or 161, for example, can reside in memory 21. Similarly, device 16 can have a client business system 24 which can run various business applications or embody parts or all of system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

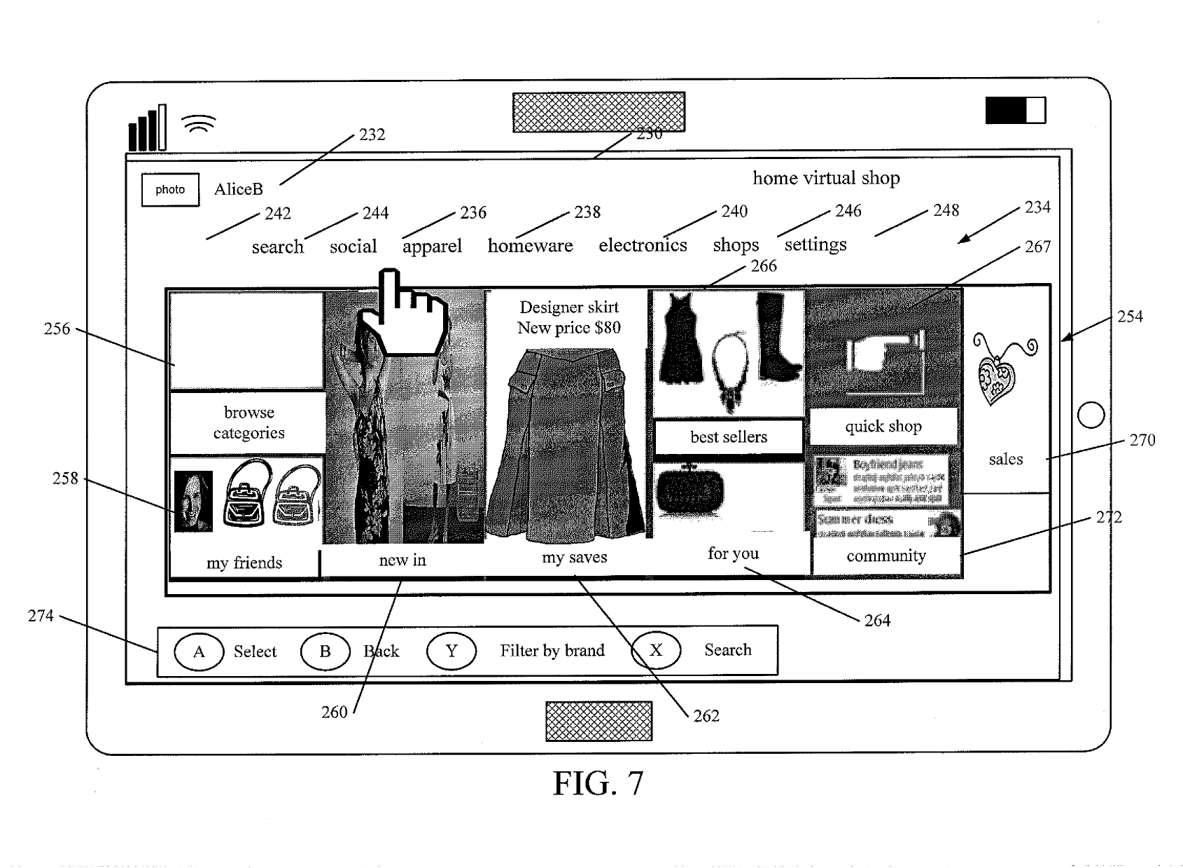

FIGS. 6 and 7 show an embodiment in which device 16 is a tablet computer 600. In FIG. 7, computer 600 is shown with display 304 on screen 602. FIG. 7 shows computer 600 with display 230 on screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

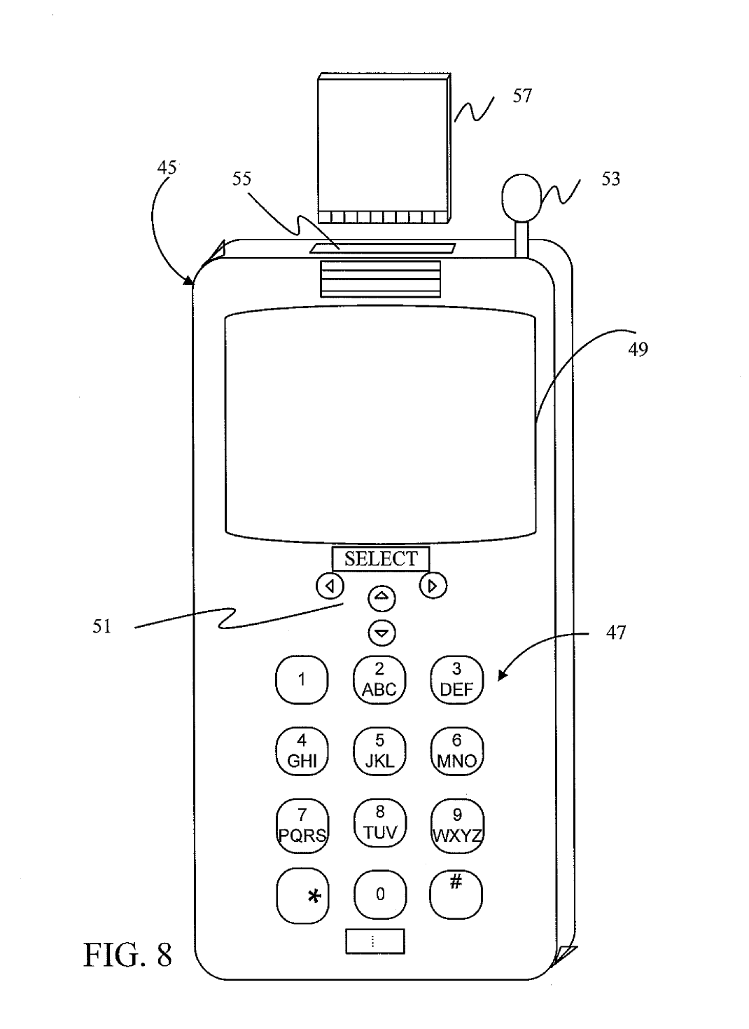

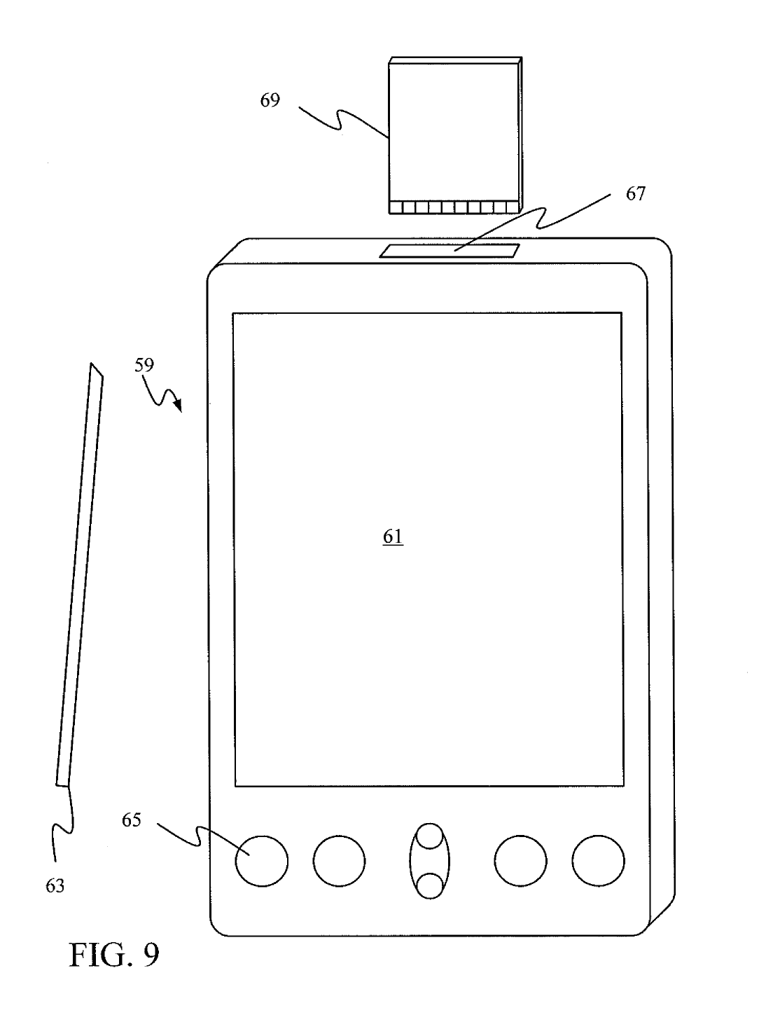

FIGS. 8 and 9 provide additional examples of devices 16 that can be used, although others can be used as well. In FIG. 8, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 9 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 16 are possible.

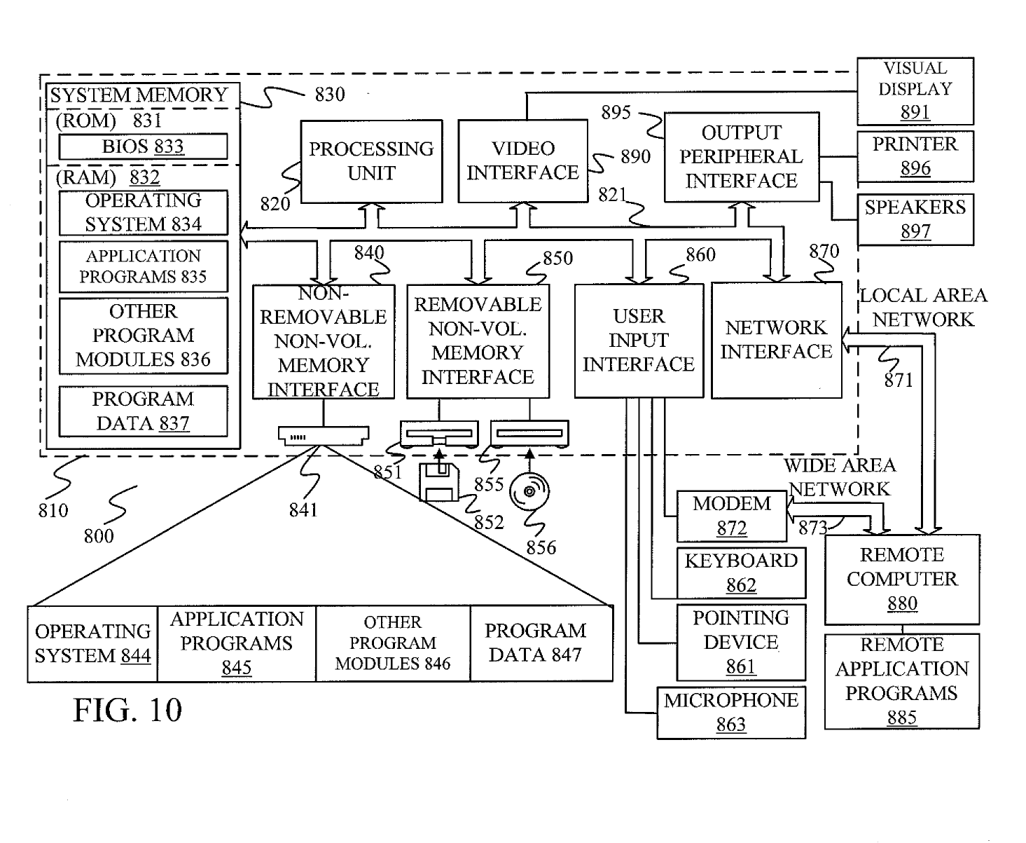

FIG. 10 is one embodiment of a computing environment in which system 100 (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processors 112 and 146), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method of performing shopping services, comprising:
displaying a shopper browsing user interface (UI) display on a display device, the shopper UI display including user input mechanisms receiving browsing user inputs;
receiving, at a processor, the browsing user inputs through the shopper browsing UI display and displaying additional UI displays based on the browsing user inputs;
receiving, at the processor, a product selection user input selecting a product;
obtaining measurement data corresponding to the user;
displaying product data, corresponding to the selected product, based on the measurement data; and
receiving, at the processor, a conclusion user input concluding user interaction relative to the selected product.

2. The computer-implemented method of claim 1 wherein receiving the browsing user inputs comprises:
receiving the browsing user inputs through a natural user interface.

3. The computer-implemented method of claim 2 wherein receiving the browsing user inputs through a natural user interface comprises:
receiving the browsing user inputs through a motion sensing, touchless user input device.

4. The computer-implemented method of claim 3 wherein obtaining measurement data comprises:
measuring one or more body parts of the user to obtain body part measurements, using the motion sensing, touchless user input device.

5. The computer-implemented method of claim 4 wherein obtaining measurement data comprises:
calculating a user size based on the body part measurements.

6. The computer-implemented method of claim 4 wherein obtaining measurement data comprises:
estimating the body part measurements for unmeasured body parts, using standard body proportions and body part measurements for measured body parts.

7. The computer-implemented method of claim 1 wherein displaying a shopper browsing UT display, comprises:
accessing shopper data;
accessing product data, based on the shopper data, from a plurality of different sellers through a network-based shopping service that receives product data from the plurality of different sellers; and
displaying a shopper-specific display based on the product data and the shopper data.

8. The computer-implemented method of claim 7 wherein displaying a shopper-specific display, comprises:
displaying user actuatable shopping category elements based on shopper-specific shopping history, the shopping category elements, when actuated, navigating to display a subcategory display displaying user actuatable subcategory elements.

9. The computer-implemented method of claim 7 wherein displaying a shopper-specific display, comprises:
displaying user actuatable new or suggested item display elements based on shopper-specific shopping history, the new or suggested item display elements displaying one or more new or suggested items identified based on the shopper-specific data and, when actuated, navigating to display a product selection display that displays product information corresponding to the new or suggested item and a product selection user input mechanism used to select the new or suggested item.

10. The computer-implemented method of claim 7 wherein displaying a shopper-specific display, comprises:
displaying a user actuatable history display element which, when actuated, navigates to display a shopper-specific shopping history.

11. The computer-implemented method of claim 7 wherein displaying a shopper-specific display, comprises:
displaying a user actuatable notifications item that displays one or more shopper-specific notifications and which, when actuated, navigate to display a list of shopper-specific notifications.

12. The computer-implemented method of claim 11 wherein receiving a product selection user input comprises:
receiving browsing user inputs drilling down, through a succession of categories and subcategories displayed on successive additional UI displays, to a product selection display displaying a given product; and
receiving a selection user input selecting the given product from the product selection display.

13. The computer-implemented method of claim 1 wherein displaying product data, comprises:
displaying the selected product over-laid on a body type of the user that conforms to the measurement data for the user.

14. The computer-implemented method of claim 1 wherein displaying product data, comprises:
displaying the selected product in a suggested size, the suggested size being identified based on the measurement data for the user.

15. The computer-implemented method of claim 1 wherein displaying product data, comprises:
displaying an animation of the selected product.

16. The computer-implemented method of claim 1 wherein displaying product data comprises:
displaying a user actuatable social network display item which, when actuated, navigates to a social network display with social network user input mechanisms that receive user inputs to perform social network operations relative to the selected product.

17. The computer-implemented method of claim 1 wherein receiving the conclusion user input comprises:
receiving a save user input saving product information for the selected product in shopper data corresponding to the user.

18. The computer-implemented method of claim 1 wherein receiving the conclusion user input comprises:
receiving a purchase user input purchasing the selected product using a point system implemented by the game console.

19. A shopping system, comprising:
a display device;
a motion sensing, touchless user input device;
a shopping component coupled to the motion sensing, touchless user input device, the a shopping component receiving shopping user inputs from the motion sensing, touchless user input device, through shopping user interface displays displayed on the display device and accessing a network-based shopping service to perform shopping operations based on product information received from a plurality of different sellers, based on the shopping user inputs; and
a computer processor that is a functional part of the shopping system and activated by the motion sensing, touchless user input device and the shopping component to facilitate performing shopping operations.

20. A computer readable storage medium, storing computer readable instructions which, when executed by a computer, cause the computer to perform steps, comprising:
displaying a shopper browsing user interface (UI) display on a display device, the shopper UI display including user input mechanisms receiving browsing user inputs;
receiving, at a processor, the browsing user inputs through the shopper browsing UI display, through a motion sensing, touchless user input device, the browsing user inputs drilling down, through a succession of categories and subcategories displayed on successive additional UI displays, to a product selection display displaying a given product;
receiving, at the processor, a selection user input selecting the given product from the product selection display;
obtaining measurement data corresponding to the user by measuring one or more body parts of the user to obtain body part measurements, using the motion sensing, touchless user input device;
displaying product data, corresponding to the selected product, based on the measurement data; and
receiving, at the processor, a conclusion user input concluding user interaction relative to the selected product.
